(19) United States
(12) Patent Application Publication
(10) Pub. No.: US 2018/0066514 A1
(43) Pub. Date: Mar. 8, 2018

(54) DOWNHOLE TELECOMMUNICATIONS

(71) Applicant: HALLIBURTON ENERGY SERVICES, INC., Houston, TX (US)

(72) Inventors: Gregory Thomas WERKHEISER, Carrollton, TX (US); Ken SCHWENDEMANN, Flower Mound, TX (US)

(73) Assignee: HALLIBURTON ENERGY SERVICES, INC., Houston, TX (US)

(21) Appl. No.: 15/557,755

(22) PCT Filed: Apr. 16, 2015
(86) PCT No.: PCT/US2015/026214

§ 371 Date: Sep. 12, 2017

(51) Int. Cl. E21B 47/14; G01V 11/00; E21B 33/13; E21B 47/12

(52) U.S. Cl. CPC E21B 47/14; G01V 11/002; H04W 84/18; E21B 47/122; E21B 33/13

(57) ABSTRACT

An umbilical, residing in a tubing section of a drill string, for providing data uphole and downhole. The umbilical having a tubing wall, a plurality of wires and a plurality of communication devices. The tubing wall separating an interior and an exterior of the umbilical. The plurality of wires is located in the interior of the tubing section and includes at least one power wire and at least one data communication wire communicatively coupled to each of the plurality of first communication devices. Each communication device is configured to wireless receive sensor data from a tool assembly and to transmit the received sensor data uphole via the communicatively coupled at least one communication wire. The umbilical residing in an interior of a tubing section of a drill string and the tool assembly coupled with an exterior of the tubing section of the drill string.

### FIELD

The present disclosure generally relates to downhole telecommunications, and more specifically to receiving sensor data from a sensor outside the downhole tubing and using an umbilical to provide the sensor data to the surface.

### BRIEF DESCRIPTION OF THE DRAWINGS

FIG. 1 is an overview of a land-based oil and gas rig in accordance with an exemplary embodiment;

FIG. 2 is an exposed view of an umbilical in accordance with an exemplary embodiment;

FIG. 3 is a cross-sectional view of a composite umbilical in accordance with an exemplary embodiment;

FIG. 4 is an exposed view of a borehole in accordance with an exemplary embodiment;

FIG. 5 is an exposed view of the communication devices communicatively coupled to the plurality of wires in accordance with a first exemplary embodiment;

FIG. 6 is an exposed view of the communication devices communicatively coupled to the plurality of wires in accordance with a second exemplary embodiment; and

FIG. 7 is a flowchart for a method for communicating data via an umbilical in accordance with an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The term “substantially” is defined to be essentially conforming to the particular dimension, shape or other word that substantially modifies, such that the component need not be exact. For example, substantially rectangular means that the object in question resembles a rectangle, but can have one or more deviations from a true rectangle. The phrase “drill string” is defined as one or more types of connected tubulars as known in the art, and can include, but is not limited to, drill pipe, landing string, production tubing, jointed tubing, combinations thereof, or the like. The term “transceiver” is defined as a combination of a transmitter/receiver in one package but can include a separate transmitter and a separate receiver in one package or two packages.

While drilling a well, such as a gas or oil well, it is often necessary to send and/or to receive data along the borehole to communicate with downhole tools, such as sensors in tool assemblies. In conventional systems, the tool assemblies are typically coupled to the outside of a tubing section of a drill string and are able to obtain sensor data for the annulus region around the tool assembly. For some wells, the sensor data is transmitted uphole via a telemetry system. Conventional telemetry systems are externally located to the tubing section of a drill string. Such telemetry systems can be bulky and are susceptible to problems when one or more telemetry units fail which can result in the entire telemetry system failing. Alternatively, in conventional systems, the sensor data can be transmitted via one or more wires residing within an umbilical. In such conventional systems, the tool assembly is hardwired to the umbilical by making a break in a tubing wall of the drill string or using a connection where two tubing sections of the drill string are joined, such as a spider connection as known to one of ordinary skill in the art. To make a break in the tubing wall, a pressure seal can be used, however pressure seals are subject to failure which can allow undesirable contaminants from the annulus to enter the drill string. As for using a connection at the end of a tubing section of the drill string, the tool assembly locations are typically limited to being near the end of the tubing section.

The present disclosure relates to an umbilical residing in a tubular or tubing section of a drill string providing uphole telecommunications and/or downhole telecommunications. The umbilical comprises a tubing wall, a plurality of wires and a plurality of communication devices. The tubing wall separates an interior and an exterior of the umbilical. The plurality of wires is located in the interior of the tubing wall and comprises at least one power wire and at least one data communication wire. Typically, the plurality of wires includes at least one ground wire. Each of the plurality of communication devices are communicatively coupled to the at least one power wire and to the at least one communication wire. Each communication device is configured to wireless receive sensor data and to transmit the received sensor data uphole via a communicatively coupled at least one communication wire. The sensor data is generated by a tool assembly coupled to the exterior of the tubing section and is transmitted wirelessly by a wireless transceiver residing in the tool assembly. By using wireless transmission to provide the sensor data to the communication device residing in the umbilical, no breaks and/or pressure seals are needed in the tubing section. As a result, the risk of contaminants entering the tubing of the drill string is reduced. In addition, since the sensor data is transmitted uphole via the at least one communication wire, problems associated with a telemetry system located externally to the tubing section is avoided; thereby reducing issues associated with such telemetry systems.

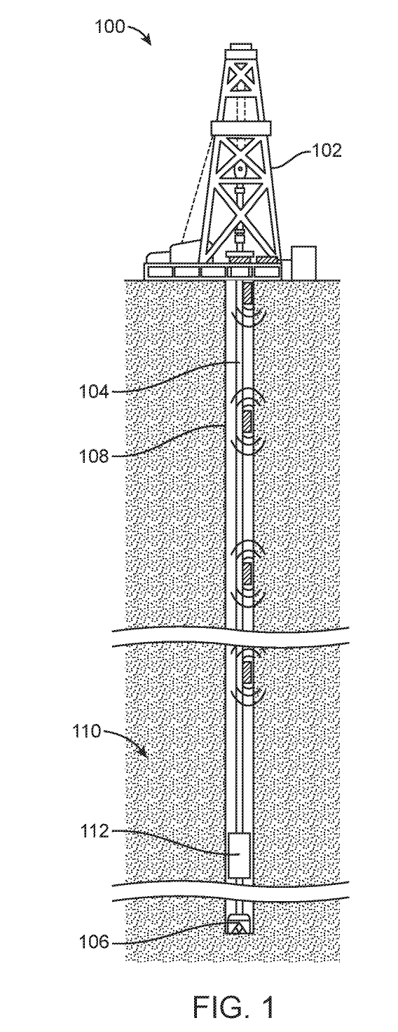

Referring to FIG. 1, an overview of a land-based oil and gas rig in accordance with an exemplary embodiment is illustrated. Although FIG. 1 depicts a land-based oil and gas rig 100, it will be appreciated by those skilled in the art that the components of the rig 100, and various embodiments of the components disclosed herein, are equally well suited for use in other types of rigs, such as offshore platforms, subsea equipment, or rigs used in any other geographical locations. The rig 100 can include a drilling platform 102 with a drill string 104 extending therefrom and configured to drive a drill bit 106. The drill bit 106 can be used to create a borehole 108 that passes through one or more subterranean formations 110. The drill string 104 can be replaced with any other downhole conveyance means known by those skilled in the art such as, but not limited to, coil tubing, wireline, slickline, and the like. The drill string 104 can include a plurality of tubulars, tubes, tubing or tube sections as known to one of ordinary skill in the art.

Although FIG. 1 depicts a vertical section of the borehole 108, the present disclosure is equally applicable for use in boreholes or wellbores having other directional configurations including horizontal wellbores, deviated wellbores, slanted wellbores, combinations thereof, and the like. The borehole 108 can have a branched structure, such as, multiple lower boreholes, also referred to as “laterals,” that split off from the upper borehole at a common point or at separate points. The disclosed systems can be deployed within a single lateral or multiple laterals without departing from the scope of this disclosure. Moreover, use of directional terms such as above, below, upper, lower, upward, downward, uphole, downhole, and the like are used in relation to the illustrative embodiments as they are depicted in the figures, the upward direction being toward the top of the corresponding figure and the downward direction being toward the bottom of the corresponding figures, the uphole direction being toward the surface of the well and the downhole direction being toward the toe or bottom of the borehole 108; these directions are merely illustrative in nature and do not limit the scope of the disclosure.

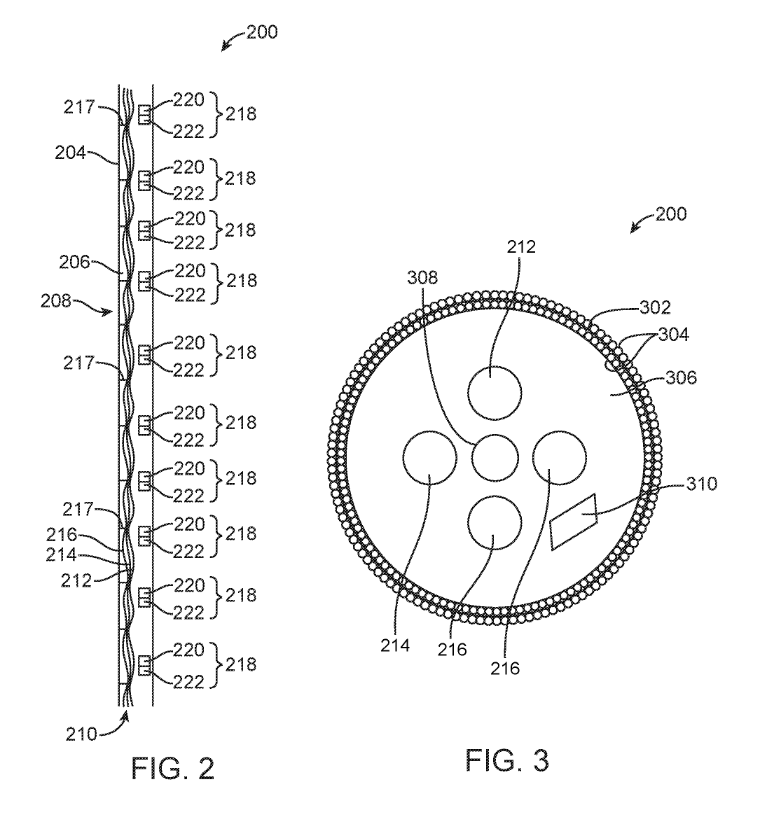

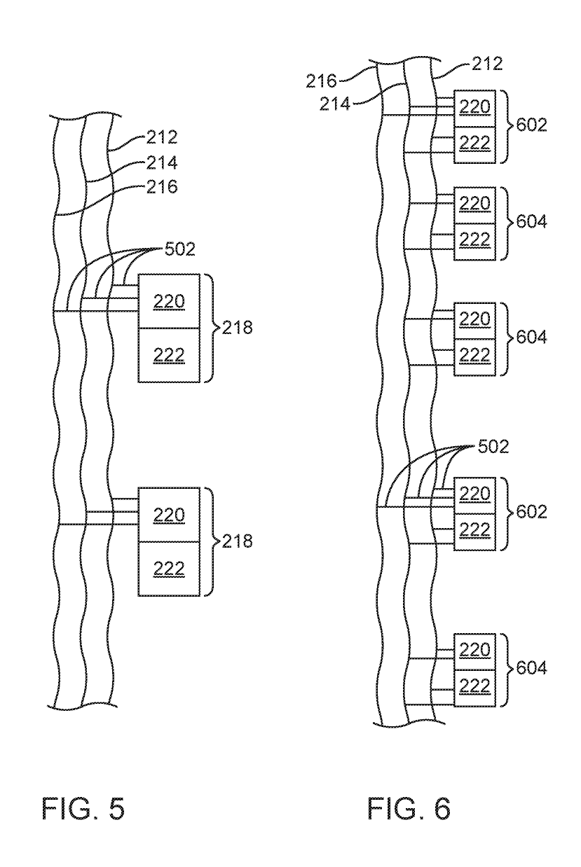

Referring to FIG. 2, an exposed view of an umbilical in accordance with an exemplary embodiment is illustrated. As shown, the umbilical 200 includes a tubing wall 204 separating an interior 206 of the umbilical 200 and an exterior 208 of the umbilical 200. A plurality of wires 210 resides in the interior 206 of the tubing wall 204. The plurality of wires 210 can include at least one power wire 212, at least one ground wire 214 and at least one communication wire 216. The plurality of wires 210 extend from one end of the umbilical 200 to the other end of the umbilical 200, for example, from the toe or bottom of the borehole 108 to the surface. The at least one power wire 212 provides power to one or more devices and/or one or more tool assemblies in the well. The at least one power wire 212 is communicatively coupled at one end to a power supply at the surface and terminates at the other end, at or near the bottom end of the umbilical 200. One or more extenders 502 provide power to one or more devices and/or one or more tool assemblies within the umbilical 200 (as shown in FIGS. 5 and 6). The at least one ground wire 214 can be communicatively coupled to a ground at the surface and can terminate at the other end, at or near the bottom of the umbilical 200. The at least one communication wire 216 can provide communications downhole and/or uphole. The at least one communication wire 216 can be unidirectional and/or bi-directional downhole or uphole as explained in further detail below.

The umbilical 200 resides within the drill string 104. The umbilical 200 can be secured to the interior of a tubing section of the drill string 104 using clamps 217 as known to one of ordinary skill in the art. As shown, clamps 217 can secure the umbilical 200 periodically. The clamps 217 can be evenly spaced apart, unevenly spaced apart or any combination thereof. One or more communication devices 218 can be secured to a tubing wall 204 of the umbilical 200. For example, as explained in more detail below, one or more resins can secure a communication device 218. Alternatively, one or more clamps can be used to secure a communication device 218 within the umbilical 200. The communication devices 218 can be evenly spaced apart, unevenly spaced apart or any combination thereof. The communication devices 218 can be spaced apart so at least one communication device 218 can wirelessly transmit and/or receive data from a tool assembly that is coupled to the exterior of the tubing wall 204 as explained in more detail below. The exterior of the tubing wall 204 can include a marking (not shown) to indicate the location of a communication device 218. The markings can provide an indication of the location of the communication devices 218 to assist in identifying where a tool assembly can be placed on the exterior of the tubing wall 204.

Referring to FIG. 3, a cross-sectional view of a composite umbilical in accordance with an exemplary embodiment is illustrated. As shown, the umbilical 200 can include a pressure layer 302, a wear layer 304, a load carrying layer 306 and an inner impermeable fluid liner or layer 308. Each layer can include one or more layers and can be braided. For example, the load carrying layer 306 typically consist of multiple layers. The plurality of wires 210 can be embedded within the load carrying layers 306. One or more sensors 310 can be embedded among the load carrying layer or layers 306. The one or more sensors 310 can be communicatively coupled with the at least one power wire 212, the at least one ground wire 214 and the at least one communication wire 216. The one or more sensors 310 can provide sensor data, such as temperature or pressure, regarding the area within the umbilical 200, around the one or more sensors 310. The outer layer of the umbilical 200 can be referred to as the tubing wall 204 of the umbilical 200.

The wear layer 304 is typically braided around the outermost load carrying layer 306. The wear layer 304 can be a sacrificial layer since it can contact the inner wall of the borehole 108 and will wear as the umbilical 200 is inserted into the borehole 108. The wear layer 304 protects the underlying load carrying layer or layers 306. One preferred wear layer is that of Kevlar™ which is a very strong material which is resistant to abrasion. Other materials, as known to one of ordinary skill in the art, can be used. Although two wear layers 304 are shown, there can be more or less wear layers as required. By having multiple wear layers 304, the different layers 304 can be of a different fiber and/or color making it easy to determine the wear locations on the umbilical 200. Different fiber and/or color can provide a marker to assist in identifying the location of a communication device 218, One skilled in the art should appreciated that the wear layer 304 and inner impermeable liner 308 and are not critical to the use of umbilical 200 and may not be required in certain applications. The pressure layer 302 can also be applied although not required. The pressure layer 302 can be the outermost layer or can be located between two or more layers of the wear layer 304.

The load carrying layers 306 can be a resin fiber having a sufficient number of layers to sustain the required load of the drill string 104 suspended in fluid, including the weight of the umbilical 200 and bottom hole assembly, for example, the drill bot 106. For example, the umbilical 200 can include six load carrying layers 306. More or less load carrying layers can be used as required. The fibers of load carrying layers 306 can be wound into a thermal setting or curable resin. Carbon fibers are preferred because of their strength, and although glass fibers are not as strong, glass fibers are much less expensive than carbon fibers. Also, a combination of carbon and glass fibers can be used. Thus, the particular fibers for the load carrying layer or layers 306 can depend upon the well, particularly the depth of the well, such that an appropriate compromise of strength and cost can be achieved in the fiber selected. Typically an all carbon fiber is preferred because of its strength and its ability to withstand pressure.

The load carrying layers 306 can provide the mechanical properties of the umbilical 200. The load carrying layers 306 can be wrapped and braided to provide the umbilical 200 with various mechanical properties including tensile and compressive strength, burst strength, flexibility, resistance to caustic fluids, gas invasion, external hydrostatic pressure, internal fluid pressure, ability to be stripped into the borehole 108, density i.e. flotation, fatigue resistance and other mechanical properties. Fibers 306 are uniquely wrapped and braided to maximize the mechanical properties of umbilical 200 including adding substantially to its strength.

The inner impermeable fluid liner or layer 308 can be an inner tube preferably made of a polymer, such as polyvinyl chloride or polyethylene. The inner impermeable fluid liner 308 can also be made of a nylon, other special polymer, or elastomer. In selecting an appropriate material for the impermeable fluid liner 308, consideration is given to the chemicals in the drilling fluids to be used in drilling the well and the temperatures to be encountered downhole. A purpose for the inner impermeable fluid liner 308 is to provide an impermeable fluid barrier since carbon fibers are not impervious to fluid migration particularly after they have been bent. The inner impermeable fluid liner 308 is impermeable to fluids and thereby isolates the load carrying layers 306 from the drilling fluids passing through a flow bore of the inner impermeable fluid liner 308. The inner impermeable fluid liner 308 can serve as a mandrel for the application of the load carrying layers 306 during the manufacturing process for the umbilical 200.

The plurality of wires 210 can include at least one power wire 212, at least one ground wire 214 and at least one communication wire 216. The at least one power wire 212 provides power from a power supply at the surface to the bottom hole assembly 106, as well as devices in between. The at least one power wire 212 can be a copper conductor. Typically, each power wire 212 is a braided copper wire. The braided cooper wire can be used to provide power to a power section 112 (as shown in FIG. 1) which rotates the bit 106. Each power wire 212 can conduct a large voltage, such as 400 volts of electricity. The at least one power wire 212 can be disposed between the two outermost load carrying layers 306. By locating the at least one power wire 212 adjacent to the outer diameter of the composite umbilical 200, the at least one power wire 212 is disposed over a greater surface area of layers 306 to maximize the dissipation of heat.

Each communication wire 216 can be a plurality of strands or cables providing communication to the controls at the surface such that data is transmitted in either direction. Fiber optic cables provide a broad band width transmission and permit two-way communication between a bottom hole assembly, such as a tool assembly 406 and/or the power section 112, and the surface. Other types of communication wires, such as metallic, can be used as known to one of ordinary skill in the art. Alternatively, as shown in FIG. 3, one or more communication wires 216 can be dedicated to transmit data downhole and another one or more communication wires 216 can be dedicated to transmit data uphole. At least one ground wire 214 can be a plurality of strands or cables and can ground the communication devices 218, tool assemblies 406 and/or sensors 310. Each of the plurality of wires 210 can include one or more sleeves to protect the wires from liquids and/or pressure.

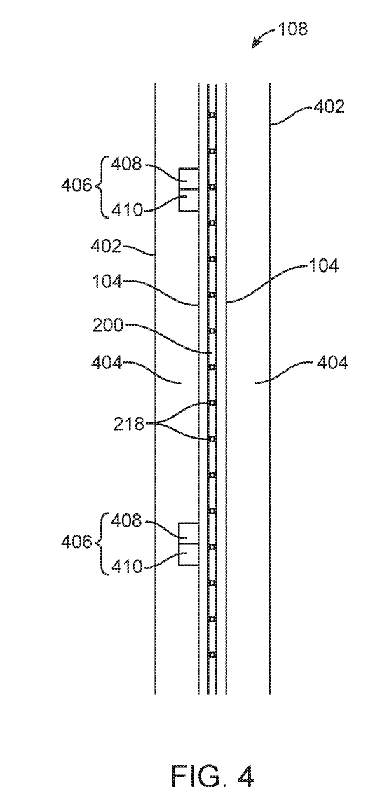

Referring to FIG. 4, a partial view of a borehole in accordance with an exemplary embodiment is illustrated. As shown, the borehole 108 can include the drill string 104, a casing 402, an annulus 404 and one or more tool assemblies 406. The drill string 104 can further include an umbilical 200 having a plurality of communication devices 218 residing on the inside of the umbilical 200. The casing 402 protects the borehole 108 from outside contaminants, as well as protecting the area outside of the casing 402 from the oil or gas that is being produced. The annulus 404 is the space between the drill string 104 and the casing 402. The annulus 404 can contain the drill cuttings and drilling fluid. One or more tool assemblies 406 can be coupled to the exterior of the tubing wall 204 of a tubular 202. For example, a clamp (not shown) can couple a tool assembly 406 to the exterior of the tubing wall 204 of the drill string 104 as known to one of ordinary skill in the art.

The tool assemblies 406 can include any downhole tool, instrument, sensor or device 408 known to those skilled in the art. For example, the tool 408 of the tool assembly 406 can include, but is not limited to, a fluid sampling sensor, a measurement while drilling (MWD) sensor, a logging while drilling (LWD) sensor, a pressure-while-drilling (PWD) sensor, a temperature sensor, a pressure sensor, an acoustic sensor, a magnetic sensor, a magnetic resonance imaging tool, a nuclear magnetic resonance tool, an electromagnetic telemetry tool, positive or negative fluid pulsers, a resistivity sensor, a packer or other wellbore isolation device, a motor, or an actuator configured to manipulate the position of an inflow control device or sliding sleeve, combinations thereof, and the like. The tool assembly 406 includes a wireless transceiver 410 to receive and transmit data between the tool 408 to at least one communication device 218 located in the tubing 202. Alternatively, the wireless transceiver 410 can be a wireless transmitter. The wireless transceiver 410 can be, but is not limited to, acoustic, inductive, EM, Bluetooth, ZigBee or radio frequency (RF). The wireless transceiver 410 can receive data, such as a command, from a wireless transceiver 222 of the communication device 218 to perform a function. In response to receiving command, the wireless transceiver 410 causes the tool 408 to perform a function, such as determine the temperature of the fluid in the annulus 404. Alternatively, the tool 408 can perform a function on a periodic basis, for example, once every minute. Once the function is performed, the data associated with the performed function can be provided to the wireless transceiver 410 for transmission uphole. Alternatively, the tool 408 can perform a function, such as determine the temperature of the fluid in the annulus 404, and can compare the obtained value with a range of values and if the obtained value is out of the range, the tool 408 can provide the obtained value to the wireless transceiver 410 for transmission uphole. For example, if the temperature exceeds the normal range of temperatures, the temperature can be transmitted uphole. The wireless transceiver 410 wirelessly transmits the data from the tool 408 to one or more corresponding communication devices 218.

Referring to FIG. 5, an exposed view of the communication devices communicatively coupled to the plurality of wires in accordance with a first exemplary embodiment is illustrated. As shown, each communication device 218 comprises a wired transceiver 220 and a wireless transceiver 222. The wired transceiver 220 and the wireless transceiver 222 can be separate devices or integrated into one device. As shown, the wired transceiver 220 is communicatively coupled with at least one power wire 212, at least one ground wire 214 and at least one communication wire 216. Extenders 502 can communicatively couple the wire transceiver 220 with at least one power wire 212, at least one ground wire 214 and at least one communication wire 216. The extenders 502 can be hardwired. For example, the plurality of wires 210 of the umbilical 200 can be spliced with the extenders 502. The wireless transceiver 222 can receive power and ground from the wired transceiver 220. Alternatively, the wireless transceiver 222 can be communicatively coupled, for example via extenders 502, with the at least one power wire 212 and at least one ground wire 216. The wired transceiver 220 can provide data between the at least one communication wire 214 and the wireless transceiver 222. The wireless transceiver 222 can transmit and/or receive data between the wired transceiver 220 and the wireless transceiver 410 of the tool assembly 406. The number and spacing of the communication devices 218 can be determined by the telecommunication capabilities of the wireless transceivers 222 of the communication devices 218 and the wireless transceivers 410 of the tool assemblies 406. Preferably, the tool assemblies 406 can be placed anywhere along the tubular 202 and provide data to the communication devices 218, however this is not a necessity. The wired communication can be, but is not limited to, acoustic, electromagnetic (EM) or radio frequency (RF). The wireless communication can be, but is not limited to, acoustic, inductive, EM, Bluetooth, ZigBee or RF.

Referring to FIG. 6, an exposed view of the communication devices communicatively coupled to the plurality of wires in accordance with a second exemplary embodiment is illustrated. FIG. 6 is similar to FIG. 5, except there are hub communication devices 602 and non-hub communication devices 604. As shown, each hub communication device 602 and non-hub communication devices 604 comprise a wired transceiver 220 and a wireless transceiver 222. The wired transceiver 220 and the wireless transceiver 222 can be separate devices or integrated into one device. As shown, the wired transceiver 220 of the hub communication devices 602 are communicatively coupled with at least one power wire 212, at least one ground wire 214 and at least one communication wire 216 and. The wired transceiver 220 of the non-hub communication devices 604 are communicatively coupled with at least one power wire 212 and at least one ground wire 216. Extenders 502 can communicatively couple the wire transceiver 220 with at least one power wire 212, at least one ground wire 214 and at least one communication wire 216. The extenders 502 can be hardwired. For example, the plurality of wires 210 of the umbilical 200 can be spliced with the extenders 502. The wireless transceiver 222 can be communicatively coupled, for example via extenders 502, with the at least one power wire 212 and at least one ground wire 216. Alternatively, the wireless transceiver 222 can receive power and ground from the at least one power wire 212 and at least one ground wire 214.

The wired transceiver 220 of the hub communication devices 602 can provide communications between the at least one communication wire 216 and the wireless transceiver 222 of the hub communication devices 602. The wireless transceivers 222 of the hub communication devices 602 can transmit and/or receive data between the wired transceiver 220 and the wireless transceiver 410 of the tool assembly 406. In addition, the wireless transceivers 222 of the hub communication devices 602 can transmit and/or receive data to and from one or more wireless transceivers 222 of the non-hub communication devices 604. The wireless transceivers 222 of the non-hub communication devices 604 can transmit and/or receive data between the wired transceivers 220 of the hub communication devices 602 and the wireless transceiver 410 of the tool assembly 406. As shown, each hub communication device 602 serves two non-hub communication devices 604. In other embodiments, each hub communication device 602 can serve more or less non-hub communication devices 604. The number of non-hub communication devices 604 that a hub communication device 602 serves is dependent on the telecommunication capabilities of the hub communication devices 602 and of the non-hub communication devices 604. By using hub communication devices 602 and non-hub communication devices 604, the non-hub communication devices 604 do not need the wired transceiver devices 220. The wired communication can be, but is not limited to, acoustic, electromagnetic (EM) or radio frequency (RF). The wireless communication can be, but is not limited to, acoustic, inductive, EM, Bluetooth, ZigBee or RF.

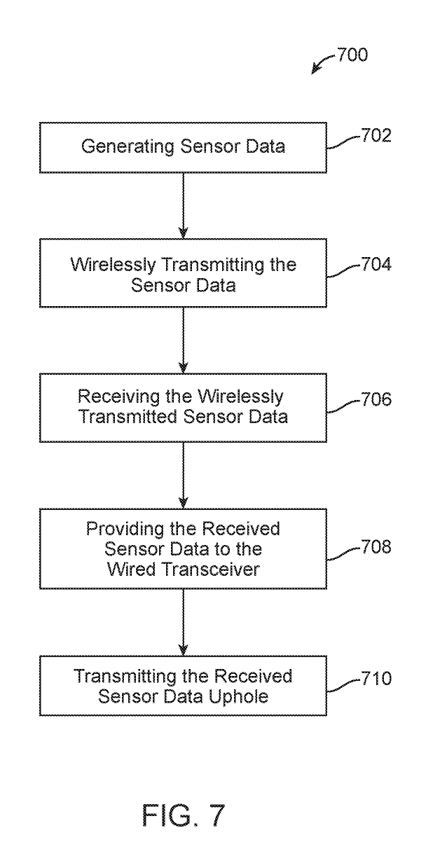

Referring to FIG. 7, a flowchart for a method for communicating data via an umbilical in accordance with an exemplary embodiment is illustrated. The exemplary method 700 is provided by way of example, as there are a variety of ways to carry out the method. The method 700 described below can be carried out using the configurations illustrated in FIGS. 1-6 by way of example, and various elements of this figure are referenced in explaining exemplary method 700. Each block shown in FIG. 7 represents one or more processes, methods or subroutines, carried out in the exemplary method 700. The exemplary method 700 can begin at block 702.

At block 702, generating sensor data. For example, a temperature sensor 408 of a tool assembly 406, coupled to the outside of a tubular wall 204 of a drill string 104, determines the temperature to generate temperature data. The sensor 408 can generate the sensor data on a periodical basis, for example, every five minutes, or in response to a command received from the surface via the communication device 218. After generating sensor data, the method 700 proceeds to block 704.

At block 704, wirelessly transmitting the sensor data. For example, a wireless transceiver 410 of a tool assembly 406, located on the outside of the tubular wall 204 of a drill string 104, transmits the sensor data to a wireless transceiver 222 of a communication device 218, located inside of the tubular wall 204 of the drill string 104. Typically, the tool assembly 408 is located adjacent to a communication device 218. After wirelessly transmitting the sensor data, the method 700 proceeds to block 706.

At block 706, receiving the wirelessly transmitted sensor data. For example, the wireless transceiver 222 of the communication device 218 receives the wireless transmitted sensor data. After receiving the wirelessly transmitted sensor data, the method 700 proceeds to block 708.

At block 708, providing the received sensor data to the wired transceiver. For example, the wireless transceiver 222 of the communication device 218 provides, either wirelessly or via hard wiring, to the wired transceiver 222 of the communication device 218. Alternatively, if the communication device 218 is a non-hub communication device 604, the wireless transceiver 222 of the non-hub communication device 604 wirelessly transmits the sensor data to a wireless transceiver 222 of a hub communication device 602 which in turn provides the sensor data to the wired transceiver 220 of the hub communication device 602 either wirelessly or via hard wiring. After providing the received sensor data to the wired transceiver 220, the method 700 proceeds to block 710.

At block 710, transmitting the received sensor data uphole. For example, the wired transceiver 220 of the communication device 218 or a hub communication device 602 transmits the received sensor data to a communication wire 216 which in turn provides the sensor data uphole to a control or computer.

Numerous examples are provided herein to enhance understanding of the present disclosure. A specific set of examples are provided as follows.

In a first example, there is disclosed an umbilical including: (a) a tubing wall separating an interior and an exterior of the umbilical; (b) a plurality of wires located in the interior of the tubing wall and comprising at least one power wire and at least one data communication wire; and (c) a plurality of communication devices located in the interior of the tubing wall, each communicatively coupled to the at least one power wire and to the at least one communication wire, each communication device configured to wireless receive sensor data from a tool assembly and to transmit the received sensor data uphole via the communicatively coupled at least one communication wire, where the umbilical is configured to reside on an interior of a tubing section of a drill string and the tool assembly coupled to an exterior of the tubing section of the drill string.

In a second example, there is disclosed an umbilical according to the preceding example, wherein each communication device comprises one of an acoustic transceiver, inductive transceiver, EM transceiver, Bluetooth transceiver, ZigBee transceiver or radio frequency (RF) transceiver.

In a third example, there is disclosed an umbilical according to any of the preceding examples, wherein the plurality of communication devices are substantially evenly spaced along the interior of the tubing wall of the umbilical.

In a fourth example, there is disclosed an umbilical according to any of the preceding examples, wherein each communication device is hardwired to the at least one power wire.

In a fifth example, there is disclosed an umbilical according to any of the preceding examples, wherein at least one communication device is hardwired to the at least one communication wire.

In a sixth example, there is disclosed an umbilical according to any of the preceding examples, further including at least one temperature sensor assembly residing within the interior of the tubing wall, each temperature sensor assembly communicatively coupled to a corresponding communication device and configured to provide temperature sensor data uphole via the corresponding communication device.

In a seventh example, there is disclosed an umbilical according to any of the preceding examples, wherein the at least one data communication wire provides communication uphole and downhole.

In an eighth example, there is disclosed an umbilical according to any of the preceding examples, having at least two communication wires with at least one of communication wires configured to provide data uphole and at least one of the communication wires configured to provide data downhole.

In a ninth example, there is disclosed a drill string comprising: (a) at least one tubing section of the drill string, the at least one tubing section having an interior and an exterior; (b) an umbilical comprising: (i) a tubing wall separating an interior and an exterior of the umbilical; (ii) a plurality of wires located in the interior of the tubing wall and comprising at least one power wire and at least one data communication wire; and (iii) a plurality of communication devices located in the interior of the tubing wall, each communicatively coupled to the at least one power wire and to the at least one communication wire, each communication device configured to wireless receive sensor data from a tool assembly and to transmit the received sensor data uphole via the communicatively coupled at least one communication wire, where the umbilical resides in the interior of a tubing section of a drill string; and (d) at least one tool assembly coupled to the exterior of the tubing section of the drill string, the at least one tool assembly comprising a sensor and a wireless transceiver configured to wirelessly transmit sensor data uphole via the communication device.

In a tenth example, there is disclosed a drill string according to the ninth example, wherein each communication device comprises one of an acoustic transceiver, inductive transceiver, EM transceiver, Bluetooth transceiver, ZigBee transceiver or radio frequency (RF) transceiver.

In an eleventh example, there is disclosed a drill string according to the ninth or tenth example, wherein each wireless transceiver comprises one of an acoustic transceiver, inductive transceiver, EM transceiver, Bluetooth transceiver, ZigBee transceiver or radio frequency (RF) transceiver.

In a twelfth example, there is disclosed a drill string according to the ninth to the eleventh examples, wherein the plurality of communication devices are substantially evenly spaced along the interior of the tubing wall of the umbilical.

In a thirteenth example, there is disclosed a drill string according to the ninth to the twelfth examples, wherein each communication device is hardwired to the at least one power wire.

In a fourteenth example, there is disclosed a drill string according to the ninth to the thirtieth examples, wherein at least one communication device is hardwired to the at least one communication wire.

In a fifteenth example, there is disclosed a drill string according to the ninth to the fourteenth examples, further including at least one temperature sensor assembly residing within the interior of the tubing section, each temperature sensor assembly communicatively coupled to a corresponding communication device and configured to provide temperature sensor data uphole via the corresponding communication device.

In a sixteenth example, there is disclosed a drill string according to the ninth to the fifteenth examples, wherein the at least one data communication wire provides communication uphole and downhole.

In a seventeenth example, there is disclosed a drill string according the ninth to the sixteenth examples, having at least two communication wires with at least one of communication wires configured to provide data uphole and at least one of the communication wires configured to provide data downhole.

In an eighteenth example, there is disclosed a method including: (a) receiving, by a wireless transceiver of a communication device, wirelessly transmitted sensor data from a wireless transceiver of a tool assembly, the communication device residing in an interior of an umbilical within a drill string and the tool assembly externally coupled with an exterior of a tubing section of a drill string; (b) providing, by the wireless transceiver of the communication device, the received sensor data to a wired transceiver of the communication device; and (c) transmitting, by the wired transceiver of the communication device, the sensor data uphole via at least one communication wire communicatively coupled to the wired transceiver.

In a nineteenth example, there is disclosed a method according to the preceding example, further including generating, by a sensor is the tool assembly, the sensor data.

In a twentieth example, there is disclosed a method according to the preceding example, further including transmitting, by a wireless transceiver of the tool assembly, the sensor data to the wireless transceiver of the communication device.

The embodiments shown and described above are only examples. Therefore, many details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. An umbilical comprising:
a tubing wall separating an interior and an exterior of the umbilical;
a plurality of wires located in the interior of the tubing wall and comprising at least one power wire and at least one data communication wire; and
a plurality of communication devices located in the interior of the tubing wall, each communicatively coupled to the at least one power wire and to the at least one communication wire, each communication device configured to wireless receive sensor data from a tool assembly and to transmit the received sensor data uphole via the communicatively coupled at least one communication wire, where the umbilical is configured to reside on an interior of a tubing section of a drill string and the tool assembly coupled to an exterior of the tubing section of the drill string.

2. The umbilical of claim 1 wherein each communication device comprises one of an acoustic transceiver, inductive transceiver, EM transceiver, Bluetooth transceiver, ZigBee transceiver or radio frequency (RF) transceiver.

3. The umbilical of claim 1 wherein the plurality of communication devices are substantially evenly spaced along the interior of the tubing wall of the umbilical.

4. The umbilical of claim 1 wherein each communication device is hardwired to the at least one power wire.

5. The umbilical of claim 1 wherein at least one communication device is hardwired to the at least one communication wire.

6. The umbilical of claim 1 further comprising at least one temperature sensor assembly residing within the interior of the tubing wall, each temperature sensor assembly communicatively coupled to a corresponding communication device and configured to provide temperature sensor data uphole via the corresponding communication device.

7. The umbilical of claim 1 wherein the at least one data communication wire provides communication uphole and downhole.

8. The umbilical of claim 1 having at least two communication wires with at least one of communication wires configured to provide data uphole and at least one of the communication wires configured to provide data downhole.

9. A drill string comprising:
at least one tubing section of the drill string, the at least one tubing section having an interior and an exterior;
an umbilical comprising:
a tubing wall separating an interior and an exterior of the umbilical;
a plurality of wires located in the interior of the tubing wall and comprising at least one power wire and at least one data communication wire; and
a plurality of communication devices located in the interior of the tubing wall, each communicatively coupled to the at least one power wire and to the at least one communication wire, each communication device configured to wireless receive sensor data from a tool assembly and to transmit the received sensor data uphole via the communicatively coupled at least one communication wire, where the umbilical resides in the interior of a tubing section of a drill string; and
at least one tool assembly coupled to the exterior of the tubing section of the drill string, the at least one tool assembly comprising a sensor and a wireless transceiver configured to wirelessly transmit sensor data uphole via the communication device.

10. The drill string of claim 9 wherein each communication device comprises one of an acoustic transceiver, inductive transceiver, EM transceiver, Bluetooth transceiver, ZigBee transceiver or radio frequency (RF) transceiver.

11. The drill string of claim 9 wherein each wireless transceiver comprises one of an acoustic transceiver, inductive transceiver, EM transceiver, Bluetooth transceiver, ZigBee transceiver or radio frequency (RF) transceiver.

12. The drill string of claim 9 wherein the plurality of communication devices are substantially evenly spaced along the interior of the tubing wall of the umbilical.

13. The drill string of claim 9 wherein each communication device is hardwired to the at least one power wire.

14. The drill string of claim 9 wherein at least one communication device is hardwired to the at least one communication wire.

15. The drill string of claim 9 further comprising at least one temperature sensor assembly residing within the interior of the tubing section, each temperature sensor assembly communicatively coupled to a corresponding communication device and configured to provide temperature sensor data uphole via the corresponding communication device.

16. The drill string of claim 9 wherein the at least one data communication wire provides communication uphole and downhole.

17. The drill string of claim 9 having at least two communication wires with at least one of communication wires configured to provide data uphole and at least one of the communication wires configured to provide data downhole.

18. A method comprising:
receiving, by a wireless transceiver of a communication device, wirelessly transmitted sensor data from a wireless transceiver of a tool assembly, the communication device residing in an interior of an umbilical within a drill string and the tool assembly externally coupled with an exterior of a tubing section of a drill string;
providing, by the wireless transceiver of the communication device, the received sensor data to a wired transceiver of the communication device; and
transmitting, by the wired transceiver of the communication device, the sensor data uphole via at least one communication wire communicatively coupled to the wired transceiver.

19. The method of claim 18 further comprising generating, by a sensor is the tool assembly, the sensor data.

20. The method of claim 19 further comprising transmitting, by a wireless transceiver of the tool assembly, the sensor data to the wireless transceiver of the communication device.
